(19) United States
(12) Patent Application Publication
(10) Pub. No.: US 2008/0042841 A1
(43) Pub. Date: Feb. 21, 2008

(54) Seal for monitoring of transported goods and method of monitoring transported goods

(75) Inventors: Martin Nedele, Reutlingen (DE); Cornelia Schlesier, Berlin (DE); Guenter Hoercher, Kirchheim/Teck (DE)

Correspondence Address: Lipsitz & McAllister, LLC, 755 MAIN STREET, MONROE, CT, 06468, US

(73) Assignees: Deutsches Zentrum fuer Luft- und Raumfahrt e.V., Koeln (DE); Fraunhofer Gesellschaft zur Foerderung der angewandten Forschung e.V., Munich (DE)

(21) Appl. No.: 11/788,745

(22) Filed: Apr. 20, 2007

Related U.S. Application Data
(63) Continuation of application No. PCT/EP05/11276, filed on Oct. 20, 2005.

(30) Foreign Application Priority Data
Oct. 29, 2004 (DE) 10 2004 053 522

(51) Int. Cl. G08B 13/14

(52) U.S. Cl. 340/572.1

(57) ABSTRACT

To provide a seal for transported goods, comprising a carrier, by means of which the seal can be fixed to an application, signal-transmitting and/or signal-receiving components disposed on the carrier, and connection lines between components, the connection lines being disposed on the carrier, the carrier is configured in such a way that, in the event of separation from an application to which the carrier has been fixed, one or more connection lines are damaged.

This application is a continuation of international application number PCT/EP2005/011276, filed on Oct. 20, 2005.

The present disclosure relates to the subject matter disclosed in international application number PCT/EP2005/011276 of Oct. 20, 2005 and German application number 10 2004 053 522.1 of Oct. 29, 2004, which are incorporated herein by reference in their entirety and for all purposes.

### BACKGROUND OF THE INVENTION

The invention relates to a seal for transported goods, comprising a carrier, by means of which the seal can be fixed to an application, signal-transmitting and/or signal-receiving components disposed on the carrier, and connection lines between components, wherein the connection lines are disposed on the carrier.

The invention further relates to a method of monitoring transported goods.

From DE 41 14 293 A1 a method and a device are known for recording temperature, atmospheric humidity, acceleration force (impacts, vibrations) and the like, which arise in a selectable, temporarily inaccessible environment, by means of a corresponding self-powered, portable device comprising sensing- and recording devices, which may be switched on and off, whereby the device is switched on for a preselected period of time, the device is disposed in the environment for a specific length of time that at least partially comprises the preselected period of time, the device is removed from the environment and the recorded values of temperature, atmospheric humidity, acceleration and the like are read and transferred to a processing device or storage device having a larger storage capacity that that of the device.

It may be necessary to monitor transported goods while in transit. For example, it is useful to monitor perishable goods to ascertain whether, in transit, conditions have arisen that are an obstacle to further use. For example, in the case of electronic goods it may be meaningful to monitor whether, in transit, circumstances have arisen that may have resulted in damage.

### SUMMARY OF THE INVENTION

In accordance with the invention, a seal is provided, which is usable in a simple and reliable manner and which comprises a monitoring device.

In an embodiment of the invention, the carrier is designed in such a way that, in the event of separation from an application to which the carrier has been fastened, one or more connection lines are damaged.

The design according to the invention of the seal makes it easy to detect whether there has been a manipulation attempt. In particular, the seal is impossible to remove from an application without damage. The application may be, for example, the transported good itself or a receptacle such as a container for transported goods. It is therefore possible to detect whether a manipulation attempt has occurred.

In particular, the carrier has at least one predetermined breaking point. It is therefore possible to produce in a simple and defined manner a line damage that is detectable.

For example, the at least one predetermined breaking point takes the form of a predetermined breaking line. The predetermined breaking point is therefore easy to manufacture.

It is particularly advantageous if the at least one predetermined breaking point is disposed transversely of one or more connection lines. This makes it easy to achieve an interruption of connection lines. This in turn makes it easy to prevent and/or detect a manipulation of the seal.

A predetermined breaking point is easy to manufacture when it is formed by a perforation.

It may be provided that the carrier is provided with an adhesive side. The carrier may then, for fixing to an application, be stuck onto said application.

It is particularly advantageous if the carrier and an adhesive coating are designed in such a way that, in the event of separation of a carrier that has been fixed to an application, the carrier is damaged. In particular, in this case connection lines are damaged. It is therefore possible to prevent manipulation of a seal.

It is quite particularly advantageous if the carrier is of a flexible design and in particular in the form of a foil. The seal may take the form of processor foil. This may easily be affixed to an application.

It is advantageous if a test device is provided, by means of which one or more connection lines may be tested for damage. It is therefore possible to carry out defined and in particular regular testing. It is then possible for example to record the data of a fault; these data are in particular time data and position data of the monitoring device.

It is advantageous if the test device transmits and/or receives test signals. In this way, faults and in particular line damage may easily be detected.

It is quite particularly advantageous if a sensor device comprising at least one sensor is provided. The at least one sensor may be used to test ambient conditions in particular to ascertain whether they may have a detrimental effect upon the transported good.

In an advantageous manner, the sensor device is disposed on the carrier. This leads to a compact seal and monitoring device, in which all of the necessary components are integrated.

For example, the sensor device comprises at least one humidity sensor. This may be used to monitor the atmospheric humidity. Too high humidity may for example have a detrimental effect on foodstuffs or on electrical, electronic and mechanical components and products.

The sensor device may also comprise at least one temperature sensor. Too high or too low temperatures may have a detrimental effect on foodstuffs or electronic products. The at least one temperature sensor may be used to carry out temperature monitoring.

It is quite particularly advantageous if the sensor device comprises at least one acceleration sensor. The at least one acceleration sensor may be used for example to monitor whether the transported good has been subjected to impacts or the like. By means of an acceleration sensor it is for example also possible to monitor an application with regard to specific forms of motion. For example, a monitoring device having a corresponding sensor device is disposed on a door of a container, namely at the inside. Opening of the container door is linked to specific acceleration data. These may be recorded. By means of the seal it may therefore be determined whether a container door was opened and in an advantageous manner the location and time of opening of the door is then simultaneously determined. This in turn allows the detection of unauthorized opening of the door.

It is also particularly advantageous if the sensor device comprises at least one position sensor for absolute position measurement. This may be for example a GPS sensor. The absolute position of the application may be determined thereby when a fault is detected.

In accordance with an embodiment of the invention, a sensor device comprising at least one sensor is provided and at least one evaluation device is provided, which tests sensor signals to ascertain whether or not a preset value or range of values has been exceeded.

In the seal as monitoring device an evaluation is carried out by means of the (at least one) evaluation device. In particular, the sensor signals are grouped in accordance with whether they lie below a threshold value or lie within or outside of a range of threshold values. In this way, sensor signals may be discriminated. This in turn makes it possible to distinguish a “normal state” from a “special state”. This creates the possibility that only “special states” need be stored. The evaluation device carries out this test and data are stored in dependence upon the test result. As a result, the storage capacity needed for the monitoring device may be kept low. What is more, when the monitoring device is read out after arrival at a transport destination, the quantity of data is kept low.

In particular, the at least one evaluation device tests the occurring sensor signals in real time and/edits these sensor signals. In the monitoring device a pre-evaluation already occurs to the effect that only “relevant data” are saved. The crucial point of monitoring is that special circumstances have to be detected, while the normal state as such is of no interest. By virtue of the solution according to the invention it is easy to realize a monitoring device, in which the storage capacity may be kept low.

In particular, the at least one evaluation device transfers data to a storage device when a preset threshold value or preset range of values is exceeded or the signals have a preset value or fall within a preset range of values. The storage device then stores only the “relevant” data, namely the data when there is non-conformance with preset limit values. Consequently, the storage capacity may be kept low.

In particular, along with the storage of data coming from the at least one evaluation device, the absolute position is stored in the storage device. It is then subsequently possible to determine the location of the monitoring device (and hence of the application) at which an exceeding of a limit value occurred. For the same reason, it is advantageous if, along with the storage of data coming from the at least one evaluation device, the time is stored in the storage device. It is then subsequently possible also to determine the (absolute) time of a fault.

It is quite particularly advantageous if a storage device for data is provided. This comprises in particular a memory, from which no data is erasable (WOM=write only memory). Thus, stored data cannot be manipulated.

It further helps to prevent data manipulation if data are stored in encrypted form in the storage device.

It is advantageous if a transfer device is provided for the external readout of stored data. Thus, for example after arrival of the transported goods the monitoring device may be read out in order for example to determine whether abnormal conditions occurred in transit and in order at the same time also to be able to determine when and where these abnormal conditions occurred.

It is possible for the transfer device to be designed in a way that allows wireless readout of data. For example, such data may be read out by means of a Bluetooth standard.

It is advantageous if an energy supply device is provided. This is in particular exchangeable and/or rechargeable.

It is further advantageous if a clock and in particular a real-time clock is provided. It is then possible to determine the time at which abnormal sensor signals arise or at which manipulation attempts occurred. With a real-time clock it is possible for example also to carry out a comparison and/or synchronization with GPS data.

The monitoring device may be used for example to seal container doors. When a container door is opened, it is then possible to determine in particular the location and time of opening.

The monitoring device may advantageously be used to monitor a container.

In accordance with the invention, a method of monitoring transported goods is provided that is easy to implement.

In accordance with an embodiment of the invention, at least one sensor transmits a sensor signal to an evaluation device, the evaluation device tests whether or not a value or preset range of values is exceeded, and in dependence upon the test result data are written into a storage device.

The method in accordance with the invention has the advantages already described in connection with the seal according to the invention.

Further advantageous embodiments have likewise already been described in connection with the seal according to the invention.

In particular, the evaluation device generates the data to be stored from one or more sensor signals. The evaluation device may for example generate data that are easy to interpret. For example, the evaluation device also ensures that the data to be stored are encrypted. A high level of security against manipulation is therefore guaranteed.

It is advantageous if a test device checks connection lines between signal-transmitting and/or signal-receiving components and/or energy supply lines for damage. It is then easy to detect manipulation. Furthermore, when position data and/or time data are regularly stored, it is possible to determine the at least approximate location and the at least approximate time of a manipulation, provided that the monitoring device has not been destroyed to the extent that it is no longer possible to read out data.

It is particularly advantageous if absolute position data and/or absolute time data are stored and in particular are stored regularly. These position data and time data may be overwritten if there are no data indicating a fault. However, if data for storage exist, it is then advantageous if associated absolute position data and/or absolute time data are stored such that they are protected against loss. It is then subsequently possible to determine in more detail and/or narrow down the circumstances of a fault.

It is also possible for position data and/or time data to be stored at preset time intervals. The preset time intervals are geared to the application; in the case of a slowly moving transported good (such as for example a container being carried by a ship), a greater time interval may be set. In the case of a stationary transported good, such as for example a stationary container in a port, it is meaningful to select shorter time intervals because easier access to the transported good by third parties is possible. Storing time data and position data at intervals allows the memory space for these data to be kept low, whilst allowing at least approximate determination of the location and time, at which sensor signals for example exceeding the preset value or preset range of values occurred or a test device detects damage.

It is quite particularly advantageous if the preset time intervals are in particular variably adjustable. This allows an optimized adaptation to an application. For example, the setting of such time intervals may be effected also in dependence upon sensor signals. If for example no movement is detected, then the time intervals may be set shorter. If a specific movement corresponding for example to transportation on a ship is detected, then the time intervals may be set longer. In this case, it is also possible to preset different time intervals, depending on the application.

The following description of preferred embodiments serves in connection with the drawings to provide a detailed explanation of the invention.

### BRIEF DESCRIPTION OF THE DRAWINGS

FIG. 1 shows a schematic block diagram of an embodiment of a monitoring device according to the invention; and

FIG. 2 shows a schematic representation of an example of use of the monitoring device according to FIG. 1.

### DETAILED DESCRIPTION OF THE INVENTION

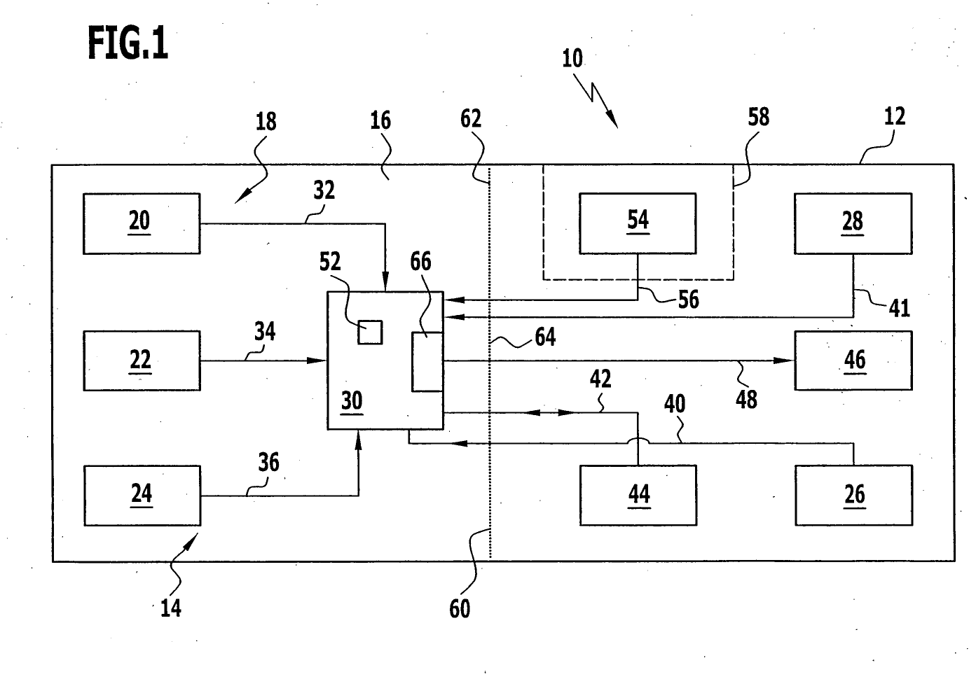

An embodiment of a seal/monitoring device according to the invention, which is shown in FIG. 1 and denoted there by 10, comprises a carrier 12, on which inter alia signal-transmitting and signal-receiving components are disposed. These are described in more detail below.

The carrier 12 is for example configured to be flexible and in particular in the form of a foil. The signal-transmitting and signal-receiving components may be integrated therein.

Connection lines, such as signal lines and energy supply lines, are disposed on the carrier 12.

In the embodiment, the carrier 12 has an adhesive side 14 (in FIG. 1 the reverse side of an upper side 16), by means of which the seal/monitoring device 10 is fastenable by adhesion to an application.

Disposed on the carrier 12 is a sensor device, which is denoted as a whole by 18 and comprises a plurality of sensors. The sensor device comprises for example a temperature sensor 20 for temperature detection. A humidity sensor 22 may further be provided for determining the humidity of the environment of the seal/monitoring device 10.

One or more acceleration sensors 24 may further be provided, by means of which changes of movement of the seal/monitoring device 10 may be determined. For example, an acceleration sensor combination may be provided, which is composed of six individual sensors. These six sensors may be used to measure the rate of rotation and acceleration for each direction in space. The acceleration sensor combination then supplies six signals.

An absolute position sensor 26 is further provided, by means of which the absolute position of the seal/monitoring device 10 may be determined. In particular, the position sensor 26 is a GPS sensor. By means of a GPS sensor a time signal may also be supplied.

A real-time clock 28 may additionally be provided to allow determination of the absolute time when signals are generated. Alternatively or additionally, by means of the real-time clock 28 it is possible to compare and/or synchronize absolute position signals that are supplied by the position sensor 26.

When a sensor device 18 comprising temperature sensor 20, humidity sensor 22, acceleration sensor 24 with six individual sensors and position sensor 26 is provided, then basically six acceleration signals, one humidity signal, one temperature signal, three position signals and one time signal may be supplied.

An evaluation device 30 is connected by signal lines to the corresponding sensors 20, 22, 24, 26 and optionally to the real-time clock 28: a signal line 32 connects the temperature sensor 20 to the evaluation device 30; a signal line 34 connects the humidity sensor 22 to the evaluation device 30; for connecting the evaluation device 30 to the acceleration sensor 24 a signal line 36 is provided. A signal line 40 connects the position sensor 26 to the evaluation device 30. A signal line 41 connects the real-time clock 28 to the evaluation device 30.

The evaluation device is so designed that it tests the sensor signals in accordance with preset test conditions and may condition sensor signals. In this case, the evaluation device 30 tests for example whether preset threshold values or preset ranges of threshold values are exceeded.

For example, it tests whether the temperature lies within a permissible temperature range. It may also test whether a permissible humidity is not exceeded. It may moreover test whether preset acceleration thresholds are not exceeded.

It may also test whether for example acceleration values lie within a preset range. It is thereby possible to test whether the monitoring device 10, and hence the application to which the seal/monitoring device 10 is fastened, has carried out a specific movement. For example, it is then possible to test whether a door, to which the seal/monitoring device 10 was fastened, has been opened.

The evaluation device 30 is connected by a signal line 42 to a storage device 44. The storage device 44 comprises in particular one or more memories, which are non-erasable (WOM=write only memory). The evaluation device 30 may transfer data, which are to be stored, via the signal line 42 to the storage device 44.

The evaluation device 30 may moreover request data from the storage device 44 so that these may be read out by means of a transfer device 46.

The transfer device 46 for this purpose is connected by a signal line 48 to the evaluation device 30.

The transfer device 46 is designed in such a way that data stored from outside in the storage device 44 may be read out. For this purpose, the transfer device 46 may be connected directly or by the evaluation device 30 to the storage device 44. The transfer of data to an external device may in this case be effected via connector contact or wirelessly such as for example Bluetooth.

With the evaluation device 30 a memory 52 may be associated, which may also be integrated in the storage device 44 and in which data relating to control of the evaluation device 30 may be stored. For example, algorithms for testing thresholds and/or ranges of threshold values may be stored and threshold values and ranges of threshold values may be stored there.

The seal/monitoring device 10 comprises an energy supply device 54, which is in particular a battery or an accumulator. The energy supply device 54 is connected by energy supply lines 56 to corresponding components of the seal/monitoring device 10. (In FIG. 1 an energy supply line 56 is shown between the energy supply device 54 and the evaluation device 30. For presentation reasons, further energy supply lines such as for example to the transfer device 46 are not shown.)

The energy supply device 54 is preferably designed such that it is rechargeable and/or exchangeable. This is indicated in FIG. 1 by a location region 58 for the energy supply device 54.

The carrier 12 is provided with one or more predetermined breaking points 60, wherein a predetermined breaking point is in particular designed as predetermined breaking line 62.

In FIG. 1 a single predetermined breaking line 62 is shown. It is however also possible to provide a plurality of predetermined breaking lines.

The at least one predetermined breaking line 62 is disposed such that it extends transversely of connection lines between components. In the embodiment shown in FIG. 1, the predetermined breaking line 62 extends transversely of the energy supply line 56 and the signal lines 40, 41, 42 and 48.

A predetermined breaking point 62 is formed for example by a perforation comprising spaced-apart recesses 64, between which bridges extend. Connection lines cross the bridges between recesses 64.

A predetermined breaking point 60 is disposed and designed in such a way that, after the seal/monitoring device 10 has been fastened to an application, in the event of separation of the carrier 12 from the application at least one connection line is damaged.

According to the invention a test device 66 is provided, which is for example part of the evaluation device 30. The test device 66 transmits and/or receives test signals in order to be able to detect connection line damage.

The seal/monitoring device 10 according to the invention operates as follows:

The seal/monitoring device 10 may be fastened by the carrier 12 to an application. The application may directly comprise a transported good or be for example a container 68, by means of which transported goods are being transported. The container 68 has for example a door 70 comprising door leaves 72 and 74.

It may be provided that the seal/monitoring device 10 is used as a seal and fastened over a door gap 76 to each of the two door leaves 72 and 74.

The seal/monitoring device 10 is fastened to an application and activated at a given time. After the transported good arrives at its final destination, the seal/monitoring device 10 is read out by means of the transfer device 46, i.e. the data stored in the storage device 44 are read out.

The seal/monitoring device 10 with its carrier 12 is designed in such a way that it is impossible to separate from an application without damage. If for example the door leaves 72, 74 are opened, this leads to damage of the carrier 12, wherein the connection lines are damaged. This damage is detectable by means of the test device 66.

For example, the test device 66 transmits signals at regular intervals to corresponding connection lines and tests whether reply signals are received within a preset period. If not, the test device 66 ensures that at least instantaneous position data and time data are written into the storage device 44 and a fault signal is written into the storage device 44.

It may also be provided that components, which are connected to the test device 66, regularly transmit test signals and the test device 66 then tests whether these also regularly arrive. If a fault is detected here, absolute position data and time data are then written into the storage device 44.

In this case, it is particularly advantageous if it is a standard procedure for absolute position data and time data to be written into the storage device 44 and in particular into a memory part that may be overwritten. If no fault is detected, these data may be overwritten. In the event of detection of a fault, the test device 66 in particular in interaction with the evaluation device 30 ensures that a warning signal is supplied to the storage device 44 and the absolute position data and time data corresponding to the fault are transferred to a non-erasable memory part.

It is then possible for example also to fix (at least approximately) absolute position data and time data for a fault if the signal line 42 is interrupted.

When and where a fault has occurred may then be subsequently read out. For example, it is then possible subsequently to read out via the transfer device 46 when and where the door 70 was opened.

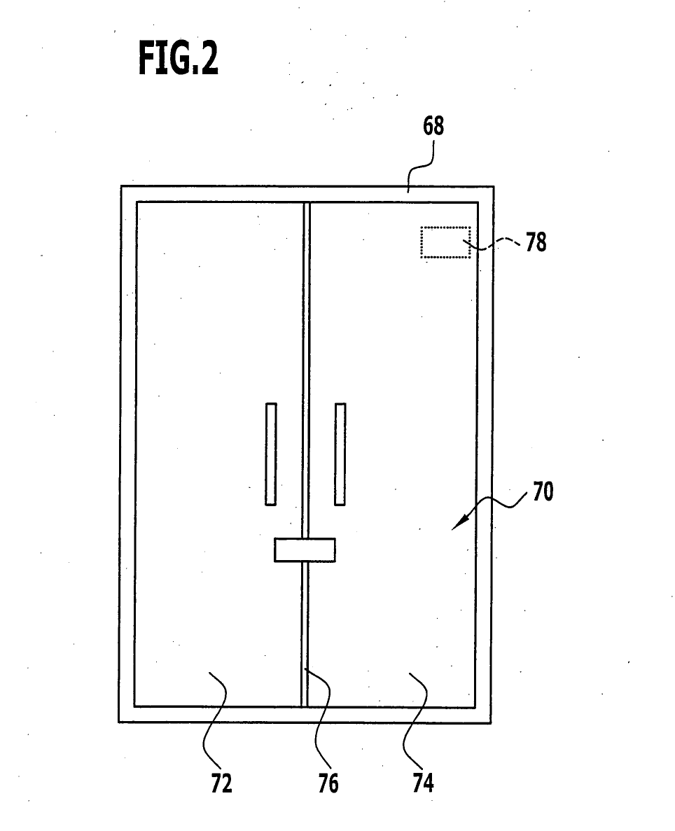

In this case, it may also be provided that a monitoring device is disposed at an “inconspicuous” point, for example between a door leaf and a container wall or on a door leaf. This is indicated in FIG. 2 by the reference character 78. The presence of a seal/monitoring device 10 is therefore not immediately apparent to third parties.

“Normal” operation of the seal/monitoring device 10 generates a large quantity of data, these being in particular the sensor signals of the sensor device 18. According to the invention it is provided that data are stored in the storage device 44 only if for example specific thresholds or ranges of threshold values are exceeded. This makes it possible to conduct monitoring for faults: by reading out the corresponding data at the transfer device 46 it is then possible subsequently to establish the type of fault, such as for example too high a temperature or excessive humidity, and to determine the time and absolute location of the transported good at which the fault occurred. The quantity of data may therefore be kept low, as only fault data are stored.

The evaluation device 30 processes and checks the occurring sensor signals in real time; it determines whether or not a threshold value or range of threshold values has been exceeded. The evaluation device 30 ensures that, depending on the test result, corresponding data are written into the storage device 44. These data can no longer be removed from the storage device 44. On the basis of the original sensor signals, the evaluation device 30 may also carry out data processing. For example, the data are encrypted before being written into the storage device 44.

Along with the “fault data”, associated data and here in particular the time of the fault and the absolute position of the seal/monitoring device 10 at the time of the fault are also written into the storage device 44.

It is also possible for time data (in particular absolute times) and position data to be written in particular at regular intervals into the storage device 44. In this case, depending on the application the time intervals are so selected that, if “fault data” are detected, the most recently stored time data and position data provide a good approximation of the location and time at which the fault data occurred.

In particular, in this case the preset time intervals are adjustable in order thereby to achieve an optimized adaptation to the corresponding application.

The seal/monitoring device 10 comprises all of the components necessary for acquiring the ambient conditions and loads upon the respective transported good, as well as all of the components for editing the generated data and for manipulation-proof storage in particular of edited data, as well as for time—and location determination.

It is advantageous if the energy supply device 54 may be activated in terms of supplying energy when the seal/monitoring device 10 is fastened by the carrier 12 to an application.

1. Seal for monitoring of transported goods, comprising:
a carrier, by means of which the seal is adapted to be fixed to an application;
at least one of signal-transmitting and signal-receiving components disposed on the carrier; and
connection lines between components, said connection lines being disposed on the carrier;
wherein the carrier is configured in such a way that, in the event of separation from an application to which the carrier is fixed, one or more connection lines are damaged;
a clock for determining the time;
a sensor device comprising at least one sensor;
wherein the sensor device comprises at least one position sensor for absolute position determination;
at least one evaluation device, which checks sensor signals to ascertain whether or not a preset value or a preset range of values has been exceeded; and
a storage device;
wherein the evaluation device transfers data to the storage device when a preset threshold value or preset range of threshold values is exceeded or signals have a preset value or fall within a preset range of values; and
wherein along with the storing of data coming from the evaluation device, the absolute position and time is stored in the storage device.

2. Seal according to claim 1, wherein the carrier has at least one predetermined breaking point.

3. Seal according to claim 2, wherein the at least one predetermined breaking point is configured as a predetermined breaking line.

4. Seal according to claim 3, wherein the at least one predetermined breaking line is disposed transversely of one or more connection lines.

5. Seal according to claim 2, wherein the at least one predetermined breaking point is formed by a perforation.

6. Seal according to claim 1, wherein the carrier is provided with an adhesive side.

7. Seal according to claim 6, wherein the carrier and an adhesive coating are so configured that, in the event of separation of a carrier that has been fixed to an application, the carrier is damaged.

8. Seal according to claim 1, wherein the carrier is of a flexible construction.

9. Seal according to claim 1, wherein the carrier is in the form of a foil.

10. Seal according to claim 1, wherein a test device is provided, of which is adapted to test one or more connection lines for damage.

11. Seal according to claim 10, wherein the test device at least one of transmits and receives test signals.

12. Seal according to claim 1, wherein the sensor device is disposed on the carrier.

13. Seal according to claim 1, wherein the sensor device comprises at least one humidity sensor.

14. Seal according to claim 1, wherein the sensor device comprises at least one temperature sensor.

15. Seal according to claim 1, wherein the sensor device comprises at least one acceleration sensor.

16. Seal according to claim 1, wherein the at least one position sensor is a GPS sensor.

17. Seal according to claim 1, wherein the at least one evaluation device checks and processes the occurring sensor signals in real time.

18. Seal according to claim 1, wherein data is stored in encrypted form in the storage device.

19. Seal according to claim 1, wherein a transmission device is provided for the external readout of stored data.

20. Seal according to claim 19, wherein the transmission device is configured in a way that allows wireless readout of data.

21. Seal according to claim 1, wherein an energy supply device is provided.

22. Seal according to claim 1, wherein the energy supply device is at least one of exchangeable and rechargeable.

23. Use of the seal according to claim 1 to monitor a container.

24. Method of monitoring transported goods, comprising:
transmitting a sensor signal by at least one sensor to an evaluation device;
checking by the evaluation device whether or not a preset value or preset range of values has been reached; and
writing data into a storage device depending on the test result;
wherein when there are data to be stored, absolute position data and absolute time data are stored therewith.

25. Method according to claim 24, wherein the evaluation device generates the data, which are to be stored, from one or more sensor signals.

26. Method according to claim 24, wherein the evaluation device encrypts the data that are to be stored.

27. Method according to claim 24, wherein a test device checks connection lines between at least one of signal-transmitting, signal-receiving components and energy supply lines for damage.

28. Method according to claim 24, wherein time data and position data are stored at preset time intervals.

29. Method according to claim 24, wherein the preset time intervals are adjustable.
